(19) United States
(12) Patent Application Publication
(10) Pub. No.: US 2023/0204738 A1
(43) Pub. Date: Jun. 29, 2023

(54) EMULATION OF A LIDAR SENSOR USING HISTORICAL DATA COLLECTED BY A LIDAR HAVING DIFFERENT INTRINSIC ATTRIBUTES

(71) Applicant: GM Cruise Holdings LLC, SAN FRANCISCO, CA (US)

(72) Inventors: Sandeep Gangundi, San Jose, CA (US); Pulkit Budhiraja, San Mateo, CA (US); Zhaoyin Jia, Palo Alto, CA (US)

(21) Appl. No.: 17/562,262

(22) Filed: Dec. 27, 2021

(51) Int. Cl. G01S 7/497; G01S 17/89; G01S 17/931

(52) U.S. Cl. CPC G01S 7/497; G01S 17/89; G01S 17/931

(57) ABSTRACT

Autonomous Vehicles (AVs) can navigate roadways without a human driver by using sensors, such as Lidar sensors, positioned around the AV. Systems, apparatuses, methods, computer readable medium, and circuits are provided for emulating a Lidar point cloud of an evaluation Lidar to be evaluated by transforming historical data received from a reference Lidar in order to determine a performance difference between the evaluation Lidar and the reference Lidar.

### DESCRIPTION OF THE RELATED TECHNOLOGY

The present technology generally pertains to using historical data from a first Lidar as a baseline dataset from which to emulate data that would be output from a second Lidar, and more particularly pertains to using the emulated data that would be output from a second Lidar to determine if the emulated Lidar would be suitable for use with an autonomous vehicle perception stack.

### SUMMARY

The present technology includes systems, apparatuses, methods, computer readable medium, and circuits for emulating a Lidar point cloud of an evaluation Lidar to be evaluated by transforming historical data received from a reference Lidar in order to determine a performance difference between the evaluation Lidar and the reference Lidar. According to at least one example, a method includes transforming point clouds represented in historical data received from the reference Lidar into emulated point clouds that emulate returns of the evaluation Lidar. A first value associated with an intrinsic attribute of the evaluation Lidar is different than a second value associated with the intrinsic attribute of the reference Lidar. Transforming the point clouds represented in historical data into emulated point clouds adjusts the point clouds represented in historical data to compensate for the difference in the first value relative to the second value. The historical data represents data for a scene collected by an autonomous vehicle that includes the point clouds received from the reference Lidar among other data descriptive of the scene as collected by the autonomous vehicle. A copy of this historical data is labeled by human labelers to create ground truth data and is an authoritative classification of objects in the scene. The reference Lidar is a particular Lidar model integrated with the autonomous vehicle. Emulated point clouds of the historical data are input into an algorithm trained to classify objects represented in point clouds and subsequently compared to the ground truth data to determine the difference in the performance of the algorithm.

### BRIEF DESCRIPTION OF THE DRAWINGS

FIG. 1 illustrates an example of a system for managing one or more Autonomous Vehicles (AVs) in accordance with some aspects of the present technology;

FIG. 2 illustrates an example Lidar emulation system 200 for emulation of an evaluation Lidar sensor in accordance with some aspects of the present technology;

FIG. 3 is a flowchart of a method for emulation of an evaluation lidar sensor for possible use with an AV using historical data in accordance with some aspects of the present technology;

FIG. 4A illustrates a first example output of the testing service of the Lidar emulation system in accordance with some aspects of the present technology;

FIG. 4B illustrates a second example output of the testing service of the Lidar emulation system in accordance with some aspects of the present technology;

FIG. 5 illustrates a graph showing output metrics of the Lidar emulation system in accordance with some aspects of the present technology;

FIG. 6 shows an example of a system for implementing certain aspects of the present technology.

### DETAILED DESCRIPTION

Autonomous Vehicles (AVs) can navigate roadways without a human driver by using sensor signals generated by multiple sensor systems positioned around the AV. One of the most common types of sensors typically used in an AV is a light sensor (e.g., light detection and ranging (LIDAR) sensor). Different types of Lidar sensors are available on the market and more are currently being developed giving AV engineers many choices when deciding which type of Lidar is the best choice to use in an AV. Lidar sensors can be classified based on the intrinsic attributes of the Lidar, which include, but are not limited to, the Lidar range, accuracy, noise in received point clouds, intensity of the laser emitted, elevation, azimuth, and field of view, among others. In addition to these intrinsic attributes, an AV engineer may also take the cost, size, and performance of the Lidar into account when deciding which type of Lidar is best for any specific AV design.

For any of the reasons mentioned above, among others, it may be advantageous for an AV engineer to replace a first type of Lidar with a second type of Lidar in an AV. In such a circumstance, the first type of Lidar (i.e. the reference Lidar) would have different intrinsic properties and likely a different cost point than the second type of Lidar (i.e. the evaluation Lidar). Previously, when an AV engineer wanted to replace a first type of Lidar (i.e. the reference Lidar) with a second type of Lidar (i.e. the evaluation Lidar) within an AV, the reference Lidar would have to be physically replaced with the evaluation Lidars on the AV within a testing environment in order to determine whether the evaluation Lidars are sufficient for a safe and properly functioning AV. This approach requires significant time and cost, and often results in a determination that the evaluation Lidar is not a sufficient replacement for the reference Lidar. Therefore, there exists a need for AV engineers to be able to test the results of replacing a first Lidar with first intrinsic properties with a second Lidar with second intrinsic properties within an AV using a computer emulation model, rather than the previous method requiring real life simulation testing. Computer emulation is cheaper and faster than real life simulation but yields substantially the same results.

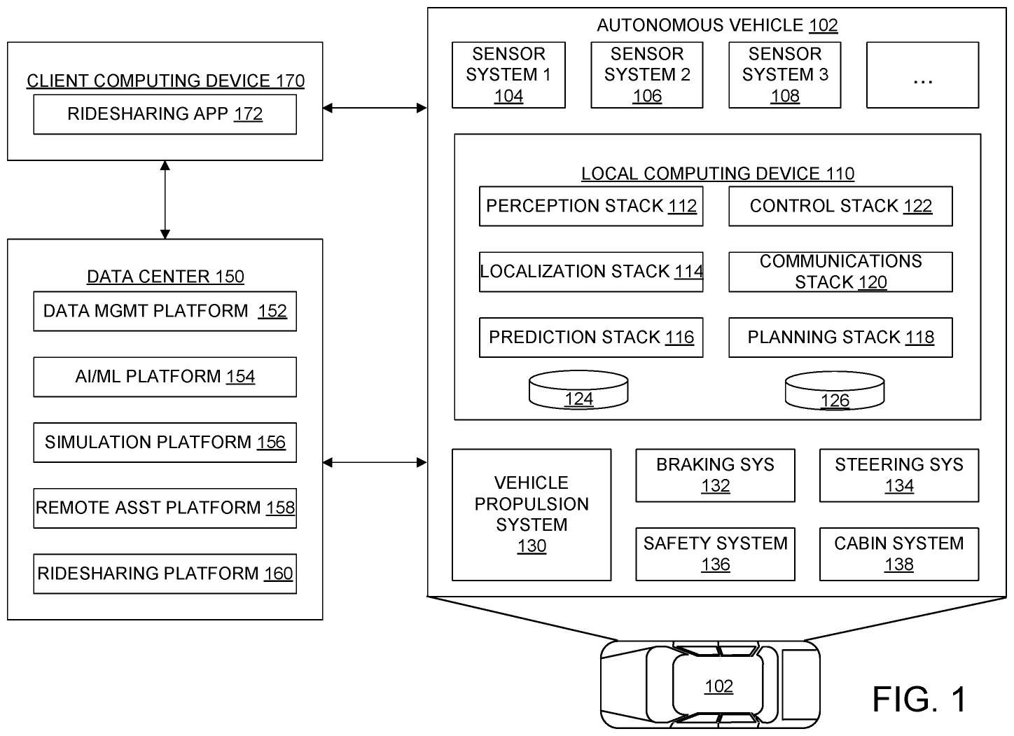

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., light detection and ranging (LIDAR) systems, ambient light sensors, infrared sensors, etc.), RADAR systems, global positioning system (GPS) receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

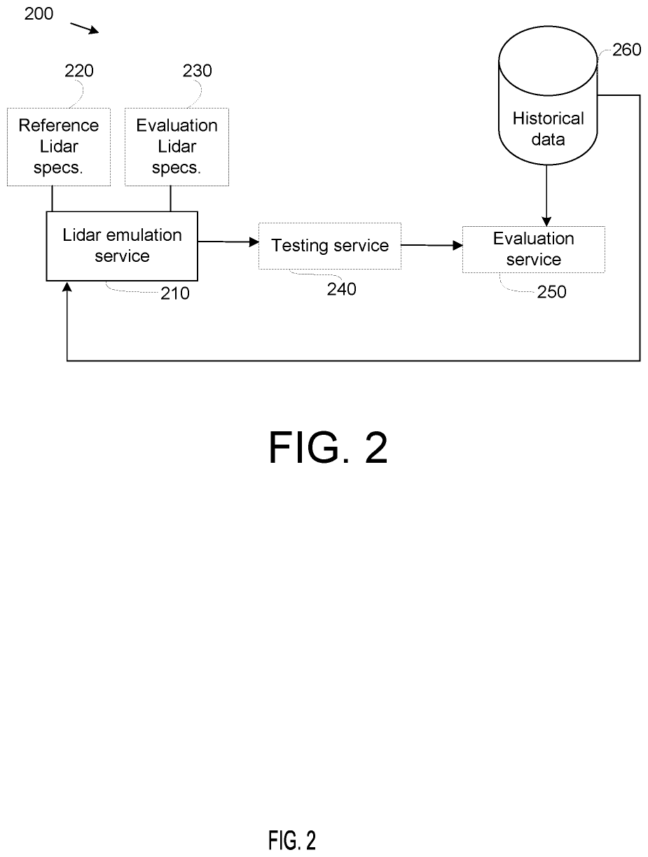

FIG. 2 illustrates an example Lidar emulation system 200 for emulation of an evaluation Lidar sensor by transforming data obtained from a reference Lidar. The reference Lidar can be a Lidar for which a substantial amount of data has been collected. In some embodiments, the performance of downstream software and hardware consumers of the reference Lidar data is well understood. The evaluation Lidar can be a Lidar for which little data or testing of the evaluation Lidar with the downstream software and hardware consumers of the Lidar data has been performed.

In some embodiments, the emulation of the evaluation Lidar sensor can be useful to efficiently gather data that appears as if the evaluation Lidar had captured it to determine whether the performance of the evaluation Lidar would be acceptable for its intended use. For example, the emulation of the evaluation Lidar sensor can be useful to determine how software on the AV 102 would perform if it were to receive data from the evaluation Lidar instead of the reference Lidar.

In some embodiments, the Lidar emulation service 210, testing service 240, and evaluation service 250 are offline services running in a data center such as, for example, data center 150. By offline, it is meant that these services are not running in a production environment, e.g., these services are not running on an AV attempting to drive autonomously. These services are in a research and design or testing environment.

The Lidar emulation service 210 includes a transform function that uses historical reference data collected by a reference Lidar with different intrinsic attributes than the evaluation Lidar to transform the point clouds represented in historical data into emulated point clouds. The Lidar emulation system 200 includes reference Lidar specifications 220 and evaluation Lidar specifications 230 operably connected to the Lidar emulation service 210 as shown in FIG. 2. The reference Lidar specifications 220 comprises one or more values associated with the intrinsic attributes of the reference Lidar including, but not limited to, Lidar range, accuracy, noise in received point clouds, intensity of laser emitted, elevation, azimuth, or field of view, among others. The evaluation Lidar database 230 comprises one or more values associated with the intrinsic attributes of the evaluation Lidar including, but not limited to, Lidar range, accuracy, noise in received point clouds, intensity of laser emitted, elevation, azimuth, or field of view, among others. In most cases, the values associated with the reference Lidar will differ from the values associated with the evaluation Lidar.

The historical data database 260 comprises point clouds previously captured by the reference lidar in use on AV 102. In addition, the historical data also includes ground truth labels associated with the point clouds previously captured by the reference Lidar. The ground truth labels are machine or human placed labels that specify what the objects in the point cloud were. In some instances, to arrive at the ground truth labels, the lidar point cloud data may have been cross-referenced with other sensor data captured at the same time. Thus the historical data database 260 includes Lidar data that can be considered authoritative. It includes data captured by a Lidar for which the properties are well known and for which the performance of the consumers of the Lidar data have been benchmarked. It also includes trusted data labels that authoritatively indicate what can or should be perceived from the Lidar data.

In operation, the Lidar emulation service 210 receives inputs from the reference Lidar database 220 as well as the evaluation Lidar database 230, and from the historical data database 260 as input values into a transform function configured to transform the point clouds represented in historical data received from the historical data database 260 into emulated point clouds that emulate returns of the evaluation Lidar based on the intrinsic properties defined by the evaluation lidar specifications 230.

In some embodiments, the transform is an empirically determined relationship between the reference Lidar values and the evaluation Lidar values for each intrinsic attribute. The transform function operating within Lidar emulation service 210 is created based on tests that compare the point clouds from the reference Lidar, with the evaluation Lidar. For example, empirical tests can determine the difference in an intrinsic noise attribute between a model of the reference Lidar and the evaluation Lidar, and that data can be used to create a transform function.

The Lidar emulation service 210 transforms point clouds represented in historical data received from the historical data database 260 into emulated point clouds that emulate returns of the evaluation Lidar. For example, in cases where a first value associated with an intrinsic attribute of the evaluation Lidar stored in the evaluation Lidar specifications 230 is different than the corresponding value associated with the intrinsic attribute of the reference Lidar stored in the reference Lidar specifications 220, the point clouds represented in historical data are adjusted by the transform function in the Lidar emulation service 210 to compensate for the difference in the first value associated with the intrinsic attribute of the evaluation Lidar relative to the second value associated with the intrinsic attribute of the reference Lidar to output an emulated point cloud.

Lidar emulation system 200 also comprises testing service 240 which receives the emulated point cloud that is outputted from the Lidar emulation service 210 as an input and tests the ability of the algorithm to adequately perform its function of classifying objects in order to determine whether the evaluation Lidar is suitable for use within the AV 102. That is, the testing service 240 comprises an algorithm that receives the emulated point cloud that is outputted from the Lidar emulation service 210 as an input and classifies the objects represented in the emulated point clouds. The testing service 240 may output the determined classification of the objects from the algorithm as bounding boxes around the objects present in the scene, including a path that the objects present in the scene have taken, kinematics of the objects present in the scene, and pose data for the objects present in the scene. In some embodiments, the algorithm is a version of the perception stack (or a portion thereof) from the AV 102 but is run offline in a testing environment. In this way, the performance of the algorithm can be evaluated when the algorithm consumes data from the emulated Lidar.

The output of the testing service 240 is evaluated by evaluation service 250 to evaluate the performance of the algorithm that is trained to classify the objects represented in the emulated point clouds. The evaluation service 250 compares the output classification of the objects from the algorithm trained to classify objects represented in point clouds with the ground truth data from historical data database 260. For example, the evaluation service 250 may determine a difference in the performance of the algorithm trained to classify objects represented in point clouds using the emulated point clouds as input compared to using the point clouds represented in the historical data 260 as input.

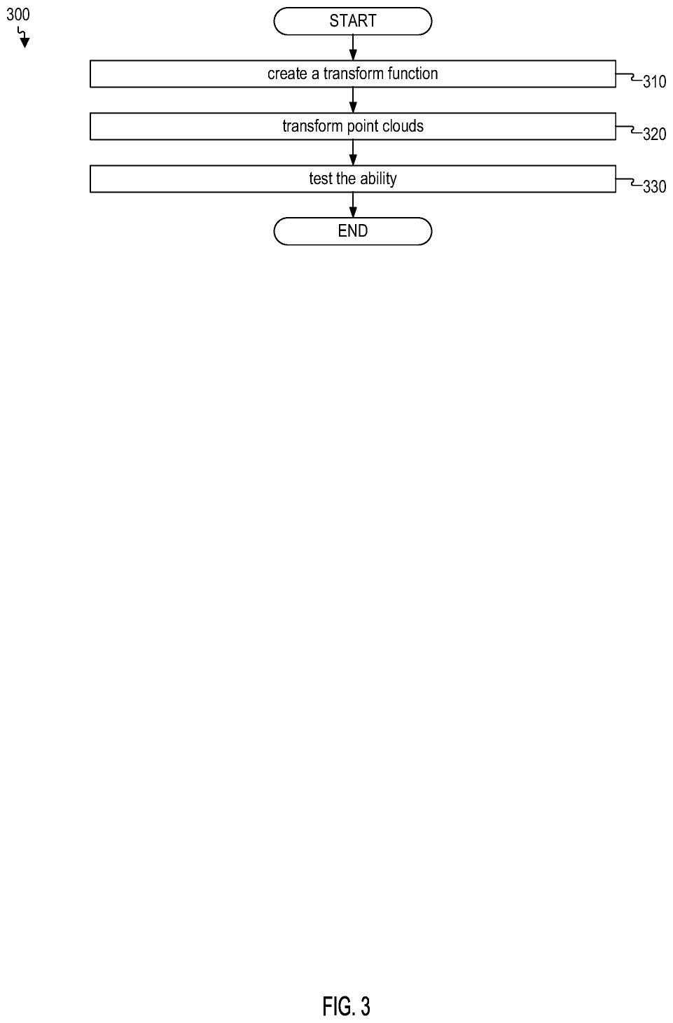

FIG. 3 illustrates an example method 300 for emulation of an evaluation lidar sensor within an AV using historical data collected by a reference lidar with different intrinsic attributes. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some embodiments, the method includes creating a transform function configured to transform the point clouds represented in historical data into emulated point clouds at block 310. For example, the Lidar emulation service 210 illustrated in FIG. 2 may create a transform function configured to transform the point clouds represented in historical data received from the reference Lidar into emulated point clouds that emulate returns of the evaluation Lidar. One or more values associated with the intrinsic attributes of the evaluation Lidar differ from the values associated with the intrinsic attributes of the reference Lidar. These intrinsic attributes can include Lidar range, accuracy, noise in received point clouds, intensity of laser emitted, elevation, azimuth, or field of view, among others.

In some embodiments, the software function incorporates an empirically determined relationship between the reference Lidar and the evaluation Lidar for the intrinsic attribute. The empirically determined relationship may be determined by conducting tests comparing point clouds from a model of Lidar that is the same of the reference Lidar, and the evaluation Lidar, for example. For example, wherein the intrinsic attribute is noise, empirical tests can determine the difference in a noise intrinsic attribute between a model of the reference Lidar and the evaluation Lidar that can be used by a transform function. The noise added can be proportional to the range of an object from the Lidar.

According to some embodiments, the method includes transforming point clouds represented in historical data received from the reference Lidar into emulated point clouds that emulate returns of the evaluation Lidar at block 320. For example, the Lidar emulation service 210 illustrated in FIG. 2 may transform point clouds represented in historical data received from the reference Lidar database 220 into emulated point clouds that emulate returns of the evaluation Lidar database 230. In some embodiments, a first value associated with an intrinsic attribute of the evaluation Lidar is different than a second value associated with the intrinsic attribute of the reference Lidar. In such a situation, the point clouds represented in historical data are adjusted by a transform function to compensate for the difference in the first value associated with the intrinsic attribute of the evaluation Lidar relative to the second value associated with the intrinsic attribute of the reference Lidar to result in the emulated point clouds. The historical data may include data collected by an autonomous vehicle that includes the point clouds received from the reference Lidar, among other data descriptive of the scene, and is labeled ground truth data that is an authoritative classification of objects in a scene. In some embodiments, the reference Lidar is a particular Lidar model integrated with the autonomous vehicle.

According to some embodiments, as shown in block 330 of FIG. 3, the method includes testing the ability of the algorithm to adequately perform its function of classifying objects using the emulated point clouds in order to determine whether the evaluation Lidar is suitable for use within the AV 102. For example, the testing device 240 illustrated in FIG. 2 is equipped to test the ability of the algorithm to adequately perform its function of classifying objects in the emulated point clouds in order to determine if the evaluation Lidar is suitable for use.

In some embodiments, the algorithm trained to classify objects represented in point clouds is a collection of algorithms in a perception stack that is configured to classify objects present in the scene. In some embodiments, the perception stack is configured to output bounding boxes around the objects present in the scene, a path that the objects present in the scene have taken, kinematics of the objects present in the scene, and pose data for the objects present in the scene.

In some embodiments, the inputting the emulated point clouds into the algorithm of the testing device 240, the receiving a classification of objects represented in the emulated point clouds from the algorithm, and the comparing the classification of the objects from the algorithm, occurs in a testing environment designed to evaluate the performance of the perception stack.

In some embodiments, the next step, at block 330, in the method includes testing the ability to correctly classify objects by inputting the emulated point clouds into the algorithm trained to classify objects represented in point clouds. For example, the testing service 240 illustrated in FIG. 2 may input the emulated point clouds into the algorithm trained to classify objects represented in point clouds in evaluation service 250.

Further, the method comprises receiving a classification of objects represented in the emulated point clouds from the algorithm trained to classify objects represented in point clouds. For example, the evaluation service 250 illustrated in FIG. 2 may receive a classification of objects represented in the emulated point clouds from the algorithm trained to classify objects represented in point clouds.

Further, the method comprises comparing the classification of the objects from the algorithm trained to classify objects represented in point clouds to the ground truth data. For example, the evaluation service 250 illustrated in FIG. 2 is configured to compare the classification of the objects from the algorithm trained to classify objects represented in point clouds to the ground truth data.

Further, the method comprises determining a difference in the performance of the algorithm trained to classify objects represented in point clouds using the emulated point clouds as input compared to using the point clouds represented in the historical data as input. For example, the evaluation service 250 illustrated in FIG. 2 may determine a difference in performance of the algorithm trained to classify objects represented in point clouds using the emulated point clouds as input as compared to using the point clouds represented in the historical data as input.

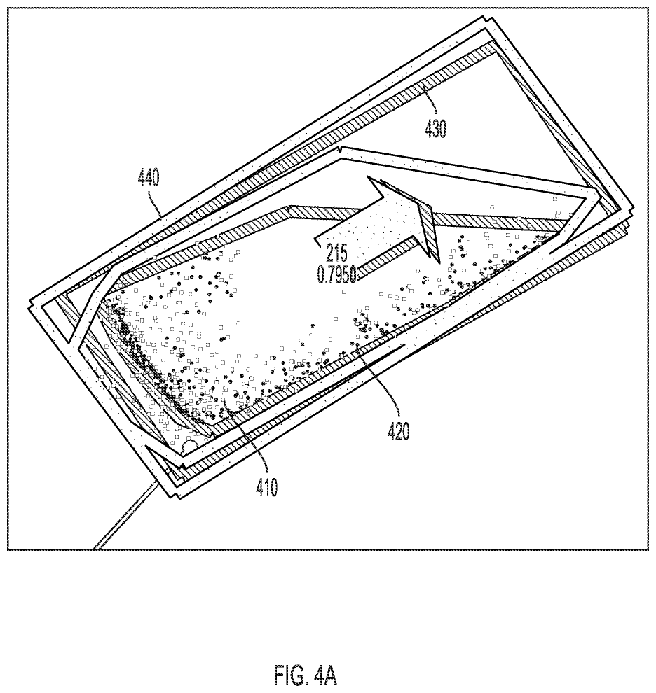

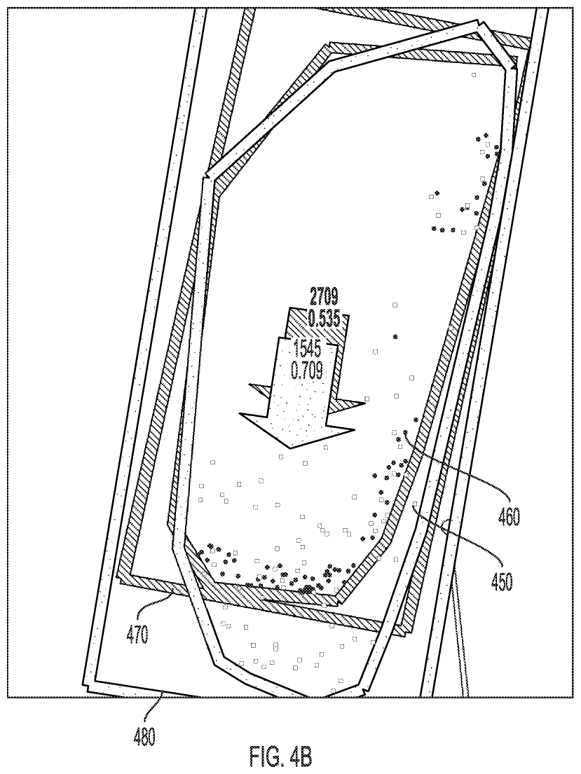

FIG. 4A illustrates an example output of testing service 240 of Lidar emulation system 200. In FIG. 4A, the noise emulated Lidar has 1% greater noise than the emulated Lidar and the distance is 30 meters. These outputs can be used by evaluation service 250 to determine the difference in performance of the algorithm trained to classify objects represented in point clouds using the emulated point clouds as input as compared to using the point clouds represented in the historical data as input. FIG. 4 shows two sets of point clouds: points 410 illustrate point clouds represented in the historical data, and points 420 illustrate the emulated point clouds output from the Lidar emulation service 210. FIG. 4A further shows bounding boxes 430 and 440, which correspond to the bounding boxes output by the testing service 240 based on analysis of the historical point cloud data and the emulated point cloud data, respectively. As shown in FIG. 4A, the evaluation Lidar bounding box is slightly less accurate than the historical bounding box. The evaluation service 250 compares the accuracy of the bounding boxes to determine the effectiveness of the evaluation Lidar and whether it is sufficient for use in an AV.

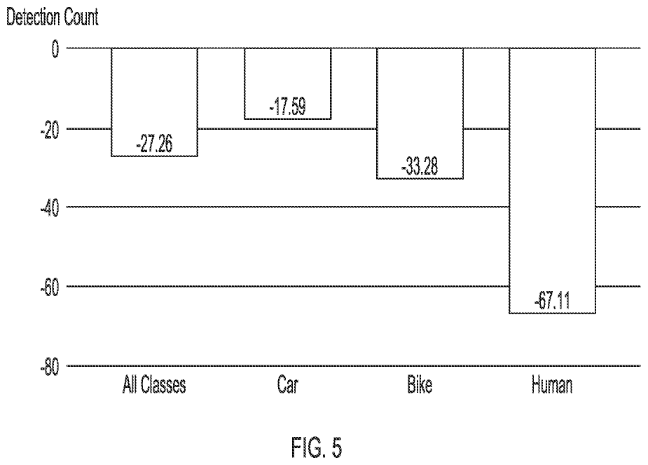

FIG. 4B illustrates a second example output of testing service 240 of Lidar emulation system 200 wherein the noise level difference is also 1%, but the distance is increased to 54 meters. Like FIG. 4A, FIG. 4B shows two sets of point clouds: points 450 illustrate point clouds represented in the historical data and points 460 illustrate the emulated point clouds output from the Lidar emulation service 210 as well as bounding boxes 470 and 480, which correspond to the bounding boxes output by the testing service 240 based on analysis of the historical point cloud data and the emulated point cloud data, respectively. Comparing the results of the bounding boxes illustrated in FIG. 4A, at 30 meters, with the results of the bounding boxes illustrated in FIG. 4B, at 54 meters shows that the accuracy is decreased at a larger distance. The evaluation service 250 can determine whether such a less accurate output is sufficient for use by an AV. FIG. 5 illustrates a graph showing the relationship between perception metrics and noise difference of 1% based on the output of the Lidar emulation system 200. The graph shows that the evaluation Lidars are least effective at determining the presence of humans, and most effective at determining the presence of another car near the AV. This data is helpful in determining which evaluation Lidars are the best match for the AV based on the overall cost and effectiveness of the system.

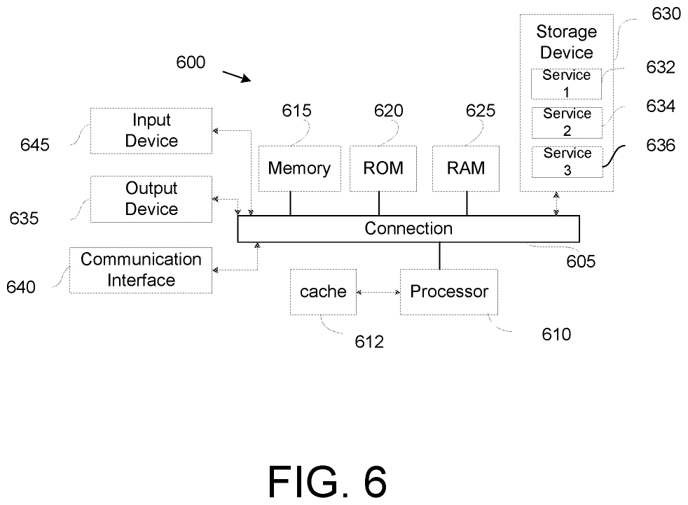

FIG. 6 shows an example of computing system 600, which can be for example any computing device making up Lidar emulation service 210, testing service 240, or evaluation service 250, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) 610 and connection 605 that couples to various system components including system memory 615, such as read-only memory (ROM) 620 and random access memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement, and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative Examples of the Disclosure Include:

Aspect 1: A method for emulating a Lidar point cloud of an evaluation Lidar to be evaluated by transforming historical data received from a reference Lidar in order to determine a performance difference between the evaluation Lidar and the reference Lidar when the point cloud data from the respective Lidar is input into an algorithm trained to classify objects represented in point clouds, the method comprising: transforming point clouds represented in historical data received from the reference Lidar into emulated point clouds that emulate returns of the evaluation Lidar, wherein a first value associated with an intrinsic attribute of the evaluation Lidar is different than a second value associated with the intrinsic attribute of the reference Lidar, whereby the transforming the point clouds represented in historical data into emulated point clouds adjusts the point clouds represented in historical data to compensate for the difference in first value relative to the second value to result in the emulated point clouds, wherein the historical data represents data for a scene collected by an autonomous vehicle that includes the point clouds received from the reference Lidar among other data descriptive of the scene as collected by the autonomous vehicle, and labeled ground truth data that is an authoritative classification of objects in the scene, wherein the reference Lidar is a particular Lidar model integrated with the autonomous vehicle; inputting the emulated point clouds into the algorithm trained to classify objects represented in point clouds; receiving a classification of objects represented in the emulated point clouds from the algorithm trained to classify objects represented in point clouds; comparing the classification of the objects from the algorithm trained to classify objects represented in point clouds to the ground truth data; and determining a difference in performance of the algorithm trained to classify objects represented in point clouds using the emulated point clouds as input as compared to using the point clouds represented in the historical data as input.

Aspect 2: The method of Aspect 1, wherein the algorithm trained to classify objects represented in point clouds is a collection of algorithms in a perception stack that is configured to data descriptive of the scene as collected by the autonomous vehicle, including the point clouds, to classify objects present in the scene.

Aspect 3: The method of any of Aspects 1 to 2, wherein the perception stack is further configured to output bounding boxes around the objects present in the scene, a path that the objects present in the scene have taken, kinematics of the objects present in the scene, and pose data for the objects present in the scene.

Aspect 4: The method of any of Aspects 1 to 3, wherein the inputting the emulated point clouds into the algorithm, the receiving a classification of objects represented in the emulated point clouds from the algorithm, and the comparing the classification of the objects from the algorithm, occurs in a testing environment designed to evaluate the performance of the perception stack.

Aspect 5: The method of any of Aspects 1 to 4, wherein the transforming the point clouds represented in historical data into emulated point clouds further comprises: creating a transform function configured to transform the point clouds represented in historical data into emulated point clouds, wherein the software function incorporates an empirically determined relationship between the reference Lidar and the evaluation Lidar for the intrinsic attribute.

Aspect 6: The method of any of Aspects 1 to 5, wherein the empirically determined relationship is determined by conducting tests comparing point clouds from a model of Lidar that is the same of the reference Lidar, and the evaluation Lidar, for example, empirical tests can determine that a difference in a noise intrinsic attribute can modeled by a transform function wherein the noise added is proportional to the range of an object from the Lidar.

Aspect 7: The method of any of Aspects 1 to 6, wherein the intrinsic attribute includes a Lidar range, accuracy, noise in received point clouds, intensity of laser emitted, elevation, azimuth, or field of view, among others.

What is claimed is:

1. A method comprising:
transforming point clouds represented in historical data received from a reference Lidar into emulated point clouds that emulate returns of an evaluation Lidar;
inputting the emulated point clouds into an algorithm trained to classify objects represented in point clouds;
receiving a classification of objects represented in the emulated point clouds from the algorithm trained to classify objects represented in point clouds; and
comparing the classification of the objects from the algorithm trained to classify objects represented in point clouds to ground truth data.

2. The method of claim 1, wherein a first value associated with an intrinsic attribute of the evaluation Lidar is different than a second value associated with the intrinsic attribute of the reference Lidar.

3. The method of claim 1, wherein the historical data represents data for a scene collected by an autonomous vehicle that includes the point clouds received from the reference Lidar, and labeled ground truth data that is an authoritative classification of objects in the scene.

4. The method of claim 1, further comprising:
determining a difference in performance of the algorithm trained to classify objects represented in point clouds using the emulated point clouds as input as compared to using the point clouds represented in the historical data as input.

5. The method of claim 1, wherein the inputting the emulated point clouds into the algorithm, the receiving a classification of objects represented in the emulated point clouds from the algorithm, and the comparing the classification of the objects from the algorithm, occurs in a testing environment designed to evaluate the performance of the algorithm.

6. The method of claim 1, wherein the transforming the point clouds represented in historical data into emulated point clouds further comprises:
creating a transform function configured to transform the point clouds represented in historical data into emulated point clouds, wherein the software function incorporates an empirically determined relationship between the reference Lidar and the evaluation Lidar for the intrinsic attribute.

7. The method of claim 1, wherein the intrinsic attribute includes a Lidar range, accuracy, noise in received point clouds, intensity of laser emitted, elevation, azimuth, or field of view, among others.

8. A system for emulating a Lidar point cloud of an evaluation Lidar to be evaluated by transforming historical data received from a reference Lidar in order to determine a performance difference between the evaluation Lidar and the reference Lidar when the point cloud data from the respective Lidar is input into an algorithm trained to classify objects represented in point clouds, comprising:
a storage configured to store instructions;
a processor configured to execute the instructions and cause the processor to:
transform point clouds represented in historical data received from a reference Lidar into emulated point clouds that emulate returns of an evaluation Lidar,
input the emulated point clouds into an algorithm trained to classify objects represented in point clouds,
receive a classification of objects represented in the emulated point clouds from the algorithm trained to classify objects represented in point clouds, and
compare the classification of the objects from the algorithm trained to classify objects represented in point clouds to ground truth data.

9. The system of claim 8, wherein a first value associated with an intrinsic attribute of the evaluation Lidar is different than a second value associated with the intrinsic attribute of the reference Lidar.

10. The system of claim 8, wherein the historical data represents data for a scene collected by an autonomous vehicle that includes the point clouds received from the reference Lidar, and labeled ground truth data that is an authoritative classification of objects in the scene.

11. The system of claim 8, wherein the processor is configured to execute the instructions and cause the processor to:
determine a difference in performance of the algorithm trained to classify objects represented in point clouds using the emulated point clouds as input as compared to using the point clouds represented in the historical data as input.

12. The system of claim 8, wherein the inputting the emulated point clouds into the algorithm, the receiving a classification of objects represented in the emulated point clouds from the algorithm, and the comparing the classification of the objects from the algorithm, occurs in a testing environment designed to evaluate the performance of the algorithm.

13. The system of claim 8, wherein the processor is configured to execute the instructions and cause the processor to:
create a transform function configured to transform the point clouds represented in historical data into emulated point clouds, wherein the software function incorporates an empirically determined relationship between the reference Lidar and the evaluation Lidar for the intrinsic attribute.

14. The system of claim 8, wherein the intrinsic attribute includes a Lidar range, accuracy, noise in received point clouds, intensity of laser emitted, elevation, azimuth, or field of view, among others.

15. A non-transitory computer readable medium comprising instructions, the instructions, when executed by a computing system, cause the computing system to:
transform point clouds represented in historical data received from a reference Lidar into emulated point clouds that emulate returns of an evaluation Lidar;
input the emulated point clouds into an algorithm trained to classify objects represented in point clouds;
receive a classification of objects represented in the emulated point clouds from the algorithm trained to classify objects represented in point clouds; and
compare the classification of the objects from the algorithm trained to classify objects represented in point clouds to ground truth data.

16. The computer readable medium of claim 15, a first value associated with an intrinsic attribute of the evaluation Lidar is different than a second value associated with the intrinsic attribute of the reference Lidar.

17. The computer readable medium of claim 15, the historical data represents data for a scene collected by an autonomous vehicle that includes the point clouds received from the reference Lidar, and labeled ground truth data that is an authoritative classification of objects in the scene.

18. The computer readable medium of claim 15, wherein the computer readable medium further comprises instructions that, when executed by the computing system, cause the computing system to:
determine a difference in performance of the algorithm trained to classify objects represented in point clouds using the emulated point clouds as input as compared to use the point clouds represented in the historical data as input.

19. The computer readable medium of claim 15, the inputting the emulated point clouds into the algorithm, the receiving a classification of objects represented in the emulated point clouds from the algorithm, and the comparing the classification of the objects from the algorithm, occurs in a testing environment designed to evaluate the performance of the algorithm.

20. The computer readable medium of claim 15, wherein the computer readable medium further comprises instructions that, when executed by the computing system, cause the computing system to:
create a transform function configured to transform the point clouds represented in historical data into emulated point clouds, wherein the software function incorporates an empirically determined relationship between the reference Lidar and the evaluation Lidar for the intrinsic attribute.
